(19) United States
(12) Patent Application Publication
(10) Pub. No.: US 2021/0398467 A1
(43) Pub. Date: Dec. 23, 2021

(54) DRIVING METHOD OF DISPLAY DEVICE, DRIVING DEVICE AND DISPLAY DEVICE

(71) Applicants: HKC CORPORATION LIMITED, Guangdong (CN); CHONGQING HKC OPTOELECTRONICS TECHNOLOGY CO., LTD., Chongqing (CN)

(72) Inventor: Mingliang Wang, Chongqing (CN)

(73) Assignees: HKC CORPORATION LIMITED, Guangdong, OT (CN); CHONGQING HKC OPTOELECTRONICS TECHNOLOGY CO., LTD., Chongqing, OT (CN)

(21) Appl. No.: 16/319,934

(22) PCT Filed: Jul. 27, 2018
(86) PCT No.: PCT/CN2018/097434

§ 371 Date: Jan. 23, 2019

(30) Foreign Application Priority Data
Aug. 31, 2017 (CN) 201710783742.X

(51) Int. Cl. G09G 3/20

(52) U.S. Cl. CPC G09G 3/20; G09G 2360/12; G09G 2370/10; G09G 2310/08

(57) ABSTRACT

A driving method of a display device, a driving device and a display device are disclosed. The driving method of the display device includes the following steps: reading, by a counter control register, first verification information stored in a memory; determining whether the first verification information read matches second verification information stored in the counter control register: if yes, then reading, by the counter control register, code information stored in the memory; if not, then stopping reading, by the counter control register, code information stored in the memory; the first verification information is stored in a read-only storage region of the memory, and the code information is stored in an erasable programmable storage region of the memory.

### TECHNICAL FIELD

The present application relates to the field of display technologies, and in particular, to a driving method of a display device, a driving device, and a display device.

### BACKGROUND

In order to realize driving of the display device and to realize correct screen display, a driving device is provided in a display device, and a memory and a counter control register (TCON) are provided in the driving device. The code information of the TCON is stored in the memory. The TCON reads the code information stored in the memory, and drives the display device according to the code information. However, the existing memory is usually an Erasable Programmable Read Only Memory (abbreviated as EPROM), and in particular, is an Electrically Erasable Programmable Read-Only Memory (abbreviated as EEPROM), in which the stored information is easily rewritten by the impact of an interference signal. During the production process of the display device, interference from wires and the like may easily cause the code information of the TCON stored in the memory to be rewritten, thereby causing the screen displayed by the display device to be abnormal and an error to occur frequently.

### SUMMARY

The main objective of the present application is to provide a driving method of a display device, which aims to solve the above technical problem that the code information stored in the memory is easily rewritten, and improve the reliability of the display device.

To achieve the above object, the present application provides a driving method of a display device, including the following steps: reading, by a counter control register, first verification information stored in a memory; determining whether the first verification information read matches second verification information stored in the counter control register: if yes, then reading, by the counter control register read, code information stored in the memory; if not, then stopping reading, by the counter control register, code information stored in the memory; and the first verification information is stored in a read-only storage region of the memory, and the code information is stored in an erasable programmable storage region of the memory

Optionally, the step of reading information stored in a memory by the counter control register includes the following steps: transmitting, by the counter control register, location information to a control region of the memory; locating, by the control region, to a storage region of the memory corresponding to the location information; and transmitting, by the storage region located, the information therein to the counter control register.

Optionally, the storage region includes the read-only storage region or the erasable programmable storage region.

Optionally, the counter control register reads information stored in the memory according to an Inter-Integrated Circuit (I2C) protocol.

Optionally, after the step of reading the code information stored in the memory by the counter control register, the driving method of a display device further includes the following steps: verifying whether the code information is correct; generating a corresponding prompt signal when the code information is incorrect; and rewriting the code information stored in the erasable programmable storage region according to the prompt signal.

The present application also provides a driving device for a display device. The driving device includes a memory, a counter control register, a micro-control unit and a driving program of the display device stored on the micro control unit and executable by the micro control unit. The memory includes a read-only storage region and an erasable programmable storage region. The read-only storage region stores first verification information, and the erasable programmable storage region stores code information. The counter control register stores second verification information that matches the first calibration information, and the micro control unit is electrically connected to the memory and the counter control register. The driving program of the display device is executed by the micro control unit to implement the steps of the driving method of the display device. The driving method of the display device includes the following steps: reading, by a counter control register, first verification information stored in a memory; determining whether the first verification information read matches second verification information stored in the counter control register: if yes, then reading, by the counter control register, code information stored in the memory; if not, then stopping reading, by the counter control register, code information stored in the memory; and the first verification information is stored in a read-only storage region of the memory, and the code information is stored in an erasable programmable storage region of the memory.

Optionally, the driving device further includes a communication bus, and the communication bus connects the control region of the memory to the counter control register.

Optionally, the communication bus is an I2C bus.

Optionally, the erasable programmable storage region includes an electrically erasable programmable storage region.

Optionally, the micro control unit is disposed in the counter control register.

The present application further provides a display device. The display device includes a display panel and a driving device. The driving device includes a memory, a counter control register, a micro control unit and a driving program of the display device stored on the micro control unit and executable by the micro control unit. The memory includes a read-only storage region and an erasable programmable storage region. The read-only storage region stores the first verification information, and the erasable programmable storage region stores code information; the counter control register stores second calibration information that matches the first calibration information; the micro control unit is electrically connected to the memory and the counter control register, and the driving program of the display device is executed by the micro control unit to implement the steps of the driving method of the display device. The driving method of the display device includes the following steps: reading, by a counter control register, first verification information stored in a memory; determining whether the first verification information read matches second verification information stored in the counter control register: if yes, then reading, by the counter control register, code information stored in the memory; if not, then stopping reading, by the counter control register, code information stored in the memory; and the first verification information is stored in a read-only storage region of the memory, and the code information is stored in an erasable programmable storage region of the memory.

Optionally, the driving device further includes a communication bus, and the communication bus connects the control region of the memory to the counter control register.

Optionally, the communication bus is an I2C bus.

Optionally, the erasable programmable storage region includes an electrically erasable programmable storage region.

Optionally, the micro control unit is disposed in the counter control register.

The driving method of the display device according to the present application includes the following steps: reading, by a counter control register, first verification information stored in a memory; determining whether the first verification information read matches second verification information stored in the counter control register: if the first verification information read matches the second verification information, then the counter control register reads code information stored in the memory; if the first verification information read does not match the second verification information, then the counter control register stops reading code information stored in the memory, so as to protect the code information in the memory and prevents it from being changed. By pre-verifying the information so as to avoid the interference signal causing the code information in the counter control register to be rewritten, the technical solution of the present application improves the reliability of the driving of the display device.

### BRIEF DESCRIPTION OF THE DRAWINGS

To illustrate the technical solutions in the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a schematic flow diagram of a driving method of a display device according to the first embodiment of the present application.

FIG. 2 is a schematic flow diagram of a driving method of a display device according to the second embodiment of the present application.

FIG. 3 is a schematic flow diagram of a driving method of a display device according to the second embodiment of the present application.

FIG. 4 is a schematic structural diagram of a display device according to an embodiment of the present application.

FIG. 5 is a schematic structural diagram of a display device according to an embodiment of the present application.

The implementation, functional features and advantages of the present application will be further described in combination with the embodiments with reference to the accompanying drawings.

### DETAILED DESCRIPTION OF THE EMBODIMENTS

The technical solutions of the present invention will be clearly and completely described in the following with reference to the accompanying drawings. It is obvious that the embodiments to be described are only a part rather than all of the embodiments of the present invention. All other embodiments obtained by persons skilled in the art based on the embodiments of the present invention without creative efforts shall fall within the protection scope of the present invention.

It should be noted that, if there is a directional indication (such as up, down, left, right, front, back, . . . ) in the embodiment of the present application, the directional indication is only used to explain the relative positional relationship between the components, and the motion situation or the like in a certain posture (as shown in the figure), and if the specific posture changes, the directional indication also changes accordingly.

In addition, if there is a description of “first”, “second”, etc. in the embodiment of the present application, the description of “first”, “second”, etc. is used for descriptive purposes only, and is not to be construed as an Its relative importance or implicit indication of the number of technical features indicated. Thus, features defining “first” or “second” may include at least one of the features, either explicitly or implicitly. In addition, the technical solutions between the various embodiments may be combined with each other, but must be based on the realization of those skilled in the art, and when the combination of the technical solutions is contradictory or impossible to implement, it should be considered that the combination of the technical solutions does not exist, nor is it within the scope of protection claimed by this application.

The present application provides a driving method of a display device.

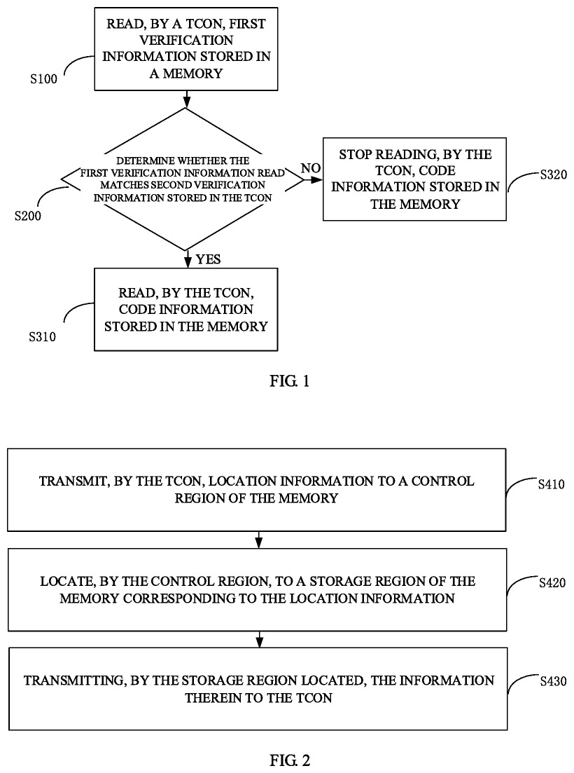

In the first embodiment of the present application, as shown in FIG. 1, the driving method of the display device includes the following steps:

Step S100: reading, by a TCON, first verification information stored in a memory.

The first verification information is stored in a read-only storage region of the memory, and the information in the read-only storage region cannot be rewritten, thereby eliminating the destruction of the first verification information by the interference signal. In this way, the first verification information is always maintained in a state as it is at the time of being storage, and thereby realizing its verification function.

Step S200: determining whether the first verification information read matches second verification information stored in the counter control register.

The second verification information may be set to be the same as the first verification information. In the process of determining whether matching or not, it is only necessary to determine whether the first verification information and the second verification information are the same. Certainly, the first verification information and the second verification information may also be different, and it is only necessary to determine whether the preset matching rule is met. During the transmission process of the first verification information, the first verification information may be changed due to the interference signal or the like. Therefore, it is possible to determine whether the communication between the TCON and the memory is normal by determining whether the first verification information read matches the second verification information.

If yes, execute step S310: reading, by the TCON, code information stored in the memory.

When the first verification information read matches the second verification information, it is indicated that the communication between the TCON and the memory is normal, and there is no interference signal capable of changing the first verification information during the communication process. At this time, the TCON reads the code information stored in the erasable programmable storage region of the memory to drive the display device. If not, execute step S320: stopping reading, by the TCON, code information stored in the memory.

When the first verification information read does not matches the second verification information, it is indicated that the communication between the TCON and the memory is abnormal, there is an interference signal capable of changing the first verification information during the communication process, and the interference is relatively strong at this time. The code information is stored in the erasable programmable storage region of the memory. If the code information stored in the erasable programmable storage region is read at this time, the code information may be changed by the interference signal. Therefore the TCON stops reading the code information stored in the memory, so as to protect code information. Certainly, the electrical connection between the TCON and the memory can be further cut off to protect the information in the memory.

The driving method of the display device according to the technical solution of the present application includes the following steps: reading, by the TCON, the first verification information stored in a memory; determining whether the first verification information read matches second verification information stored in the counter control register: if yes, then the communication between the TCON and the memory is normal, and the TCON reads the code information stored in the memory. At this time, the code information stored in the memory will not be rewritten during the communication process. If not, the communication between the TCON and memory is abnormal. At this time, there may be an interference signal that is relatively strong, resulting in the code information stored in the memory to be rewritten. Therefore, the TCON stops reading the information stored in the memory so as to protect the code information in the memory. The first verification information is stored in the read-only storage region of the memory, and the first verification information cannot be rewritten. Therefore, even if the communication is abnormal, damage will not be caused to the first verification information. In addition, the code information is stored in the erasable programmable storage region of the memory to facilitate recording different codes optically or electrically for different display devices, so that the structure of the memory is simplified, and the efficiency of the memory is improved. The read-only storage region needs to occupy only a small portion of the entire space of the memory to store the first verification information for verification, and the code information is stored in the erasable programmable storage region of the memory to drive the operation of the TCON. The read-only storage region and the erasable programmable storage region may be arranged separately, that is, they are formed by a read-only memory (ROM) and an erasable programmable memory (EPROM) connected together, or are different regions in one memory. The technical solution of the present application improves the reliability of the display device by pre-verifying the information so as to avoid the interference signal causing the code information in the TCON to be rewritten.

In the second embodiment of the present application, as shown in FIG. 2, the step of reading the information stored in the memory by the TCON includes:

step S410: transmitting, by the TCON, location information to a control region of the memory;

step S420, locating, by the control region, to a storage region of the memory corresponding to the location information;

step S430, transmitting, by the storage region located, the information therein to the TCON;

and the storage region includes a read-only storage region or an erasable programmable storage region.

Reading by the TCON the information stored in the memory includes reading the first verification information stored in the memory and reading the code information stored in the memory. Specifically, when the display device is started-up, the TCON transmits the first location information to the control region of the memory, and the control region locates to the read-only storage region of the memory according to the first location information, and the read-only storage region transmits the first verification information therein to the TCON for verification. When the verification is successful, the TCON transmits the second location information to the control region of the memory, the control region locates to the erasable programmable storage region of the memory according to the second location information, and the programmable storage region transmits the code information therein to the TCON so as to drive the display device. The control of reading information is implemented by the control region in the memory, so as to enable the driving method of the display device to operate normally.

Further, the TCON reads the information stored in the memory according to the I2C protocol. In the communication process of the I2C protocol, only two wires are needed to transfer information between devices connected to the bus. The structure is simple and flexible, and it is convenient for development.

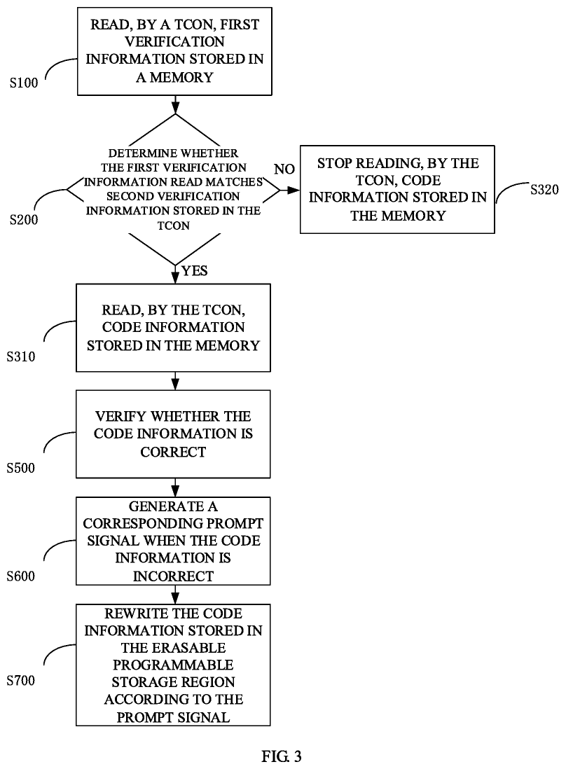

In the third embodiment of the present application, as shown in FIG. 3, after the step S310, the driving method of the display device further includes the following steps:

step S500: verifying whether the code information is correct;

step S600: generating a corresponding prompt signal when the code information is incorrect;

step S700: rewriting the code information stored in the erasable programmable storage region according to the prompt signal.

In this embodiment, considering that the code information in the erasable programmable storage region can be rewritten, although it is verified in step S100 to step S310 that the communication between TCON and memory is normal in the current state and there is no interference signal that is relatively strong, it is still difficult to ensure whether the code information in the memory has been disturbed and has been rewritten due to interference during the production process. Therefore, after being read, the code information is verified whether it is correct. If the code information is incorrect, a corresponding prompt signal is generated to remind a technician to maintain the code information in the memory, thereby further improving the driving reliability. The maintenance of the code information may include rewriting the code information stored in the erasable programmable storage region according to the specific error information of the prompt signal.

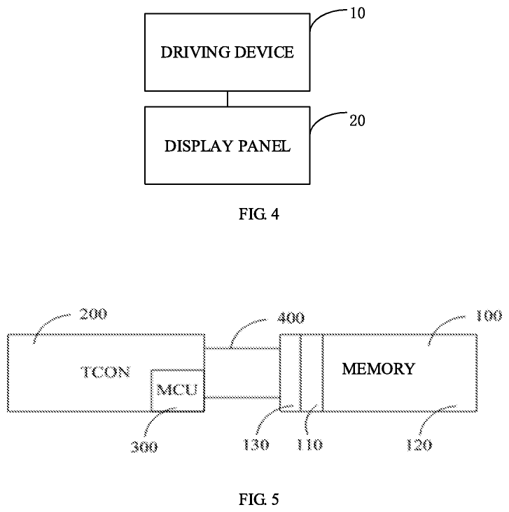

The present application also provides a driving device, as shown in FIG. 4 and FIG. 5. The driving device 10 is used for the display device. The driving device 10 includes a memory 100, a TCON 200, a micro control unit (MCU) 300 and a driving program of the display device stored on the MCU 300 and executable by the MCU 300. The memory 100 includes a read-only storage region 110 and an erasable programmable storage region 120. The read-only storage region 110 stores the first calibration information for verification, and erasable programmable storage region 120 stores code information for driving the display device; the TCON stores second verification information that matches the first verification information; and the MCU 300 is electrically connected to the memory and the TCON.

Further, the driving device includes a communication bus 400. The communication bus connects the control region 130 of the read-only memory and the TCON. The communication bus is an I2C bus, ensuring the transmission of information between the TCON and the memory according to the I2C protocol.

Further, the erasable programmable storage region includes an electrically erasable programmable storage region. The rewriting of the electrically erasable programmable storage region can be realized by applying a recording voltage higher than a normal working voltage, which can be implemented directly in the circuit and has the advantage of simple structure and easy recording.

Further, as shown in FIG. 5, the MCU 300 is disposed in the TCON, so that the driving device can be better integrated to reduce the space occupied by the driving device.

When the driving program of the display device is executed by the MCU 300, the following operations are implemented:

reading, by the TCON, the first verification information stored in a memory;

determining whether the first verification information read matches the second verification information stored in the counter control register:

if yes, then reading, by the counter control register, the code information stored in the memory;

if not, then stopping reading, by the counter control register, the code information stored in the memory.

When the driving program of the display device is executed by the MCU 300, the operation of reading the information stored in the memory by the TCON includes:

transmitting, by the TCON, location information to a control region of the memory;

locating, by the control region, to a storage region of the memory corresponding to the location information;

transmitting, by the storage region located, information therein to the TCON;

and the storage region includes the read-only storage region or the erasable programmable storage region.

When the driving program of the display device is executed by the MCU 300, the TCON reads the information stored in the memory according to the I2C protocol.

When the driving program of the display device is executed by the MCU 300, after the operation of reading the code information stored in the memory by the TCON, the following operations are also executed:

verifying whether the code information is correct;

generating a corresponding prompt signal when the code information is incorrect; and

rewriting the code information stored in the erasable programmable storage region according to the prompt signal.

The present application further provides a display device, such as a liquid crystal display (LCD), a light-emitting diode display (LED), an organic light-emitting diode display (OLED), an in-plane-switching liquid crystal display (IPS), a vertical alignment liquid crystal (VA), or other related display device. As shown in FIG. 4, the display device includes a driving device 10 and a display panel 20. The driving device 10 drives the display panel 20 to display an image. The specific structure of the driving device and the driving method of the display device refer to the above embodiments. Since the display device adopts all the technical solutions of all the above embodiments, it has at least all the beneficial effects brought by the technical solutions of the above embodiments, and will not be described in detail here.

The above description is only the preferred embodiments of the present application, and is not intended to limit the scope of the patent application. Under the inventive concept of the present application, any equivalent structural transformation or direct/indirect application made by using the contents of the specification and drawings of the present application is included in the scope of patent protection of the present application in other related technical fields.

1. A driving method of a display device, comprising the following steps:
reading, by a counter control register, first verification information stored in a memory;
determining whether the first verification information read matches second verification information stored in the counter control register:
if yes, then reading, by the counter control register, code information stored in the memory;
if not, then stopping reading, by the counter control register, code information stored in the memory;
wherein the first verification information is stored in a read-only storage region of the memory, and the code information is stored in an erasable programmable storage region of the memory.

2. The method according to claim 1, wherein the step of reading code information stored in a memory by the counter control register comprises the following steps:
transmitting, by the counter control register, location information to a control region of the memory;
locating, by the control region, to a storage region of the memory corresponding to the location information; and
transmitting, by the storage region located, the information therein to the counter control register.

3. The method according to claim 2, wherein the storage region includes the read-only storage region or the erasable programmable storage region.

4. The method according to claim 1, wherein the counter control register reads information stored in the memory according to an Inter-Integrated Circuit protocol.

5. The method according to claim 1, further comprising, after the step of reading the code information stored in the memory by the counter control register, the following steps:
verifying whether the code information is correct;
generating a corresponding prompt signal when the code information is incorrect; and
rewriting the code information stored in the erasable programmable storage region according to the prompt signal.

6. A driving device for a display device, the driving device comprising:
a memory including a read-only storage region and an erasable programmable storage region, wherein the read-only storage region stores first verification information, and the erasable programmable storage region stores code information;
a counter control register stored with second verification information that matches the first verification information;
a micro control unit electrically connected to the memory and the counter control register; and
a driving program of the display device stored on the micro control unit and executable by the micro control unit, wherein the driving program of the display device is executed by the micro control unit to implement the steps of the driving method of the display device according to claim 1.

7. The driving device according to claim 6, further comprising:
a communication bus connecting the control region of the memory to the counter control register.

8. The driving device according to claim 7, wherein the communication bus is an Inter-Integrated Circuit bus.

9. The driving device according to claim 6 wherein the erasable programmable storage region includes an electrically erasable programmable storage region.

10. The driving device according to claim 6, wherein the micro control unit is disposed in the counter control register.

11. A display device, comprising:
a display panel;
a driving device, including:
a memory including a read-only storage region and an erasable programmable storage region, wherein the read-only storage region stores first verification information, and the erasable programmable storage region stores code information;
a counter control register storing second verification information that matches the first verification information;
a micro control unit electrically connected to the memory and the counter control register; and
a driving program of the display device stored on the micro control unit and executable by the micro control unit, wherein the driving program of the display device is executed by the micro control unit to implement the steps of the driving method of the display device according to claim 1.

12. The display device according to claim 11, further comprising:
a communication bus connecting the control region of the memory to the counter control register.

13. The display device according to claim 12, wherein the communication bus is an Inter-Integrated Circuit bus.

14. The display device according to claim 11, wherein the erasable programmable storage region includes an electrically erasable programmable storage region.

15. The display device according to claim 11, wherein the micro control unit is disposed in the counter control register.
